(19) United States
(12) Patent Application Publication
(10) Pub. No.: US 2019/0204791 A1
(43) Pub. Date: Jul. 4, 2019

(54) MOBILE SMART DEVICE WITH INTEGRATED DAWN SIMULATION

(71) Applicant: Microsoft Technology Licensing, LLC, Redmond, WA (US)

(72) Inventors: Jeremiah William KEMPER, Redmond, WA (US); Brett Alan WALDBAUM, Sammamish, WA (US); Joshua Christopher KOON, Kirkland, WA (US)

(21) Appl. No.: 15/859,197

(22) Filed: Dec. 29, 2017

(51) Int. Cl. G04G 11/00; G04G 9/10; F21V 33/00; F21V 23/04

(52) U.S. Cl. CPC G04G 11/00; F21V 23/0485; F21V 33/0024; G04G 9/10

(57) ABSTRACT

The disclosed technology is generally directed to mobile clock devices. In one example of the technology, a device includes a first screen, a second screen, and a controller. The second screen is physically coupled to the first screen, and is facing a different direction than the first screen. The controller is configured to cause the first screen to operate as a clock display. The controller is further configured to cause the second screen to provide indirect light such that the indirect light gradually increases beginning at a time proximate to a predetermined time until the predetermined time is reached.

### BACKGROUND

Dawn simulation is a technique that may involve timing lights in the bedroom to come on gradually, over a period of 30 minutes to 2 hours, before awakening. Studies show that dawn simulation may be effective at treating seasonal/winter depression and seasonal affective disorder. Dawn simulation may support morning cortisol response. Dawn simulation may also help balance melatonin.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to mobile smart devices with integrated dawn simulation features. In one example of the technology, a device includes a first screen, a second screen, and a controller. In some examples, the second screen is physically coupled to the first screen, and is facing a different direction than the first screen. In some examples, the controller is configured to cause the first screen to operate as a clock display. The first screen may also operate as a display for other smart device functionality of the device. In some examples, the controller is further configured to cause the second screen to provide dawn simulation functionality, e.g., by providing indirect light such that the indirect light gradually increases beginning at a time proximate to a predetermined time until the predetermined time is reached.

The first screen may also operate to provide various smart device features. Some smart device features may include a variety of features such as email, music, video, a calculator function, a calendar function, a voice memo function, a compass function, a messaging function, a call function, an internet browser, a reading function, smart home functions, finance functions, social media functions, a health function, a shopping function, a note function, various other entertainment and productivity functions, a delivery function, and/or the like.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a device with a night light displayed on the rear screen;

FIG. 4 is a block diagram illustrating an example of a device with a dawn simulation function employed on the rear screen;

FIG. 5 is a black diagram illustrating an example of the device of FIG. 4 while showing a dawn simulation settings screen;

FIG. 6 is a block diagram illustrating a folding action of an example device;

FIG. 7 is a block diagram illustrating an example of a device; and

FIG. 8 is an example dataflow for a process, in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on”, and includes the option of being based on additional factors, some of which may not be described herein. As another example, the term “via” is not exclusive, and is equivalent to the term “via, at least in part”, and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof.

Briefly stated, the disclosed technology is generally directed to mobile smart devices with integrated dawn simulation features. In one example of the technology, a device includes a first screen, a second screen, and a controller. In some examples, the second screen is physically coupled to the first screen, and is facing a different direction than the first screen. In some examples, the controller is configured to cause the first screen to operate as a clock display. The first screen may also operate as a display for other smart device functionality of the device. In some examples, the controller is further configured to cause the second screen to provide dawn simulation functionality, e.g., by providing indirect light such that the indirect light gradually increases beginning at a time proximate to a predetermined time until the predetermined time is reached.

A two-screen device may be used to illuminate a room through direct and indirect lighting, with the front screen used as an alarm clock and as an interface for other smart functionality of the device. The device may be placed in a “tent” mode with the first screen acting as a front screen and the second screen acting as a rear screen. The device may operate as a built-in, mobile, portable alarm clock that also provide dawn simulation functions on the rear screen.

The first screen may also operate to provide various smart device features. Some smart device features may include a variety of features such as email, music, video, a calculator function, a calendar function, a voice memo function, a compass function, a messaging function, a call function, an internet browser, a reading function, smart home functions, finance functions, social media functions, a health function, a shopping function, a note function, various other entertainment and productivity functions, a delivery function, and/or the like.

### Illustrative Devices/Operating Environments

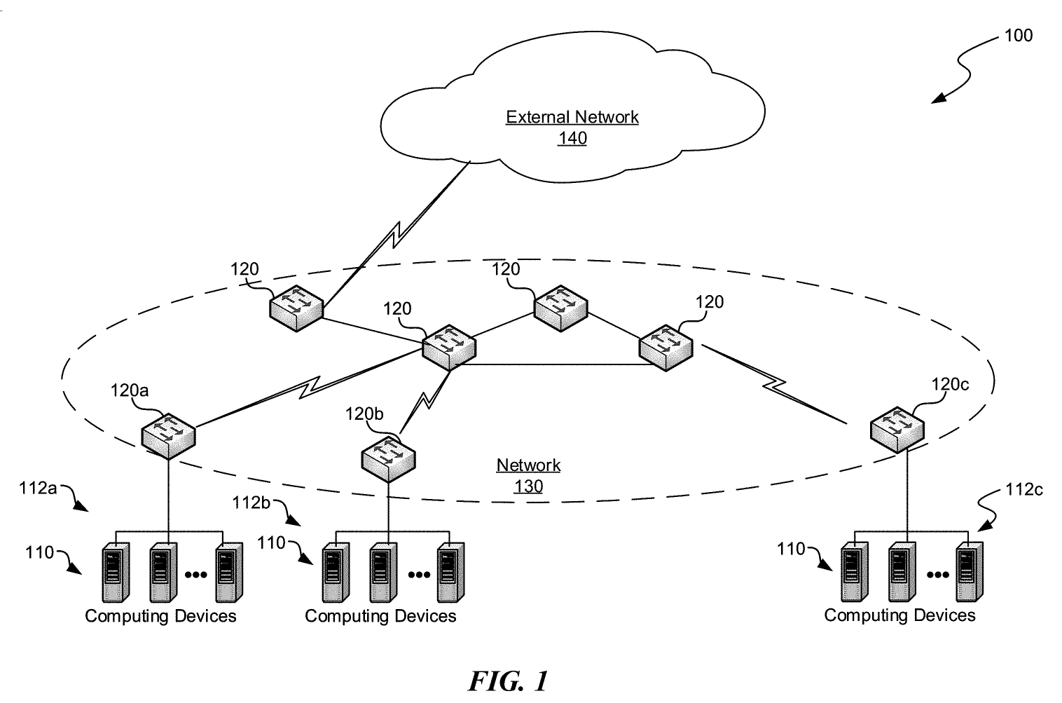

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices 110 shown in FIG. 1 may be in various locations, including on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices 110 can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices no may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

Although FIG. 1 shows an example of a device in a network environment, not all examples of the disclosure are network devices. That is, some examples of the disclosure are capable of operating as connected devices that communicate with one or more networks, and some example of the disclosure are not capable of connecting to a network.

### Illustrative Computing Device

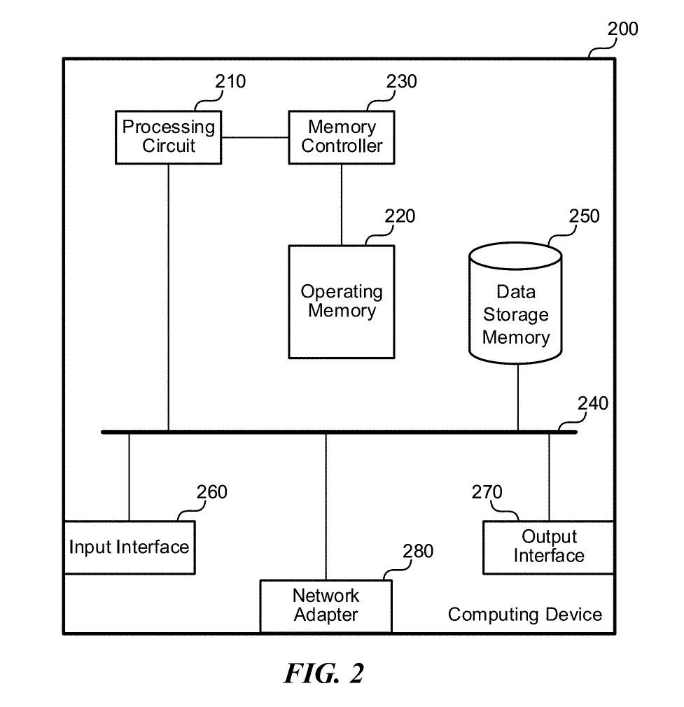

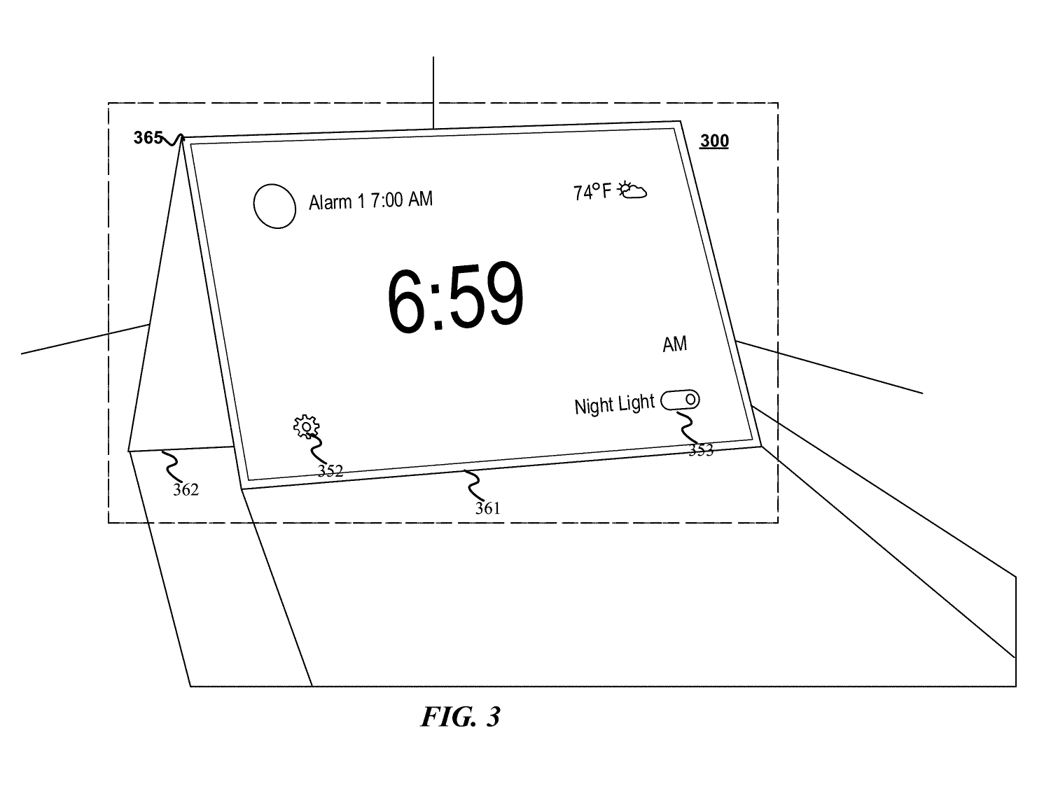

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be server device such as an application server computer, a virtual computing host computer, or a file server computer, e.g., computing device 200 may be an example of computing device no or network node 120 of FIG. 1. Computing device 200 may also be an IoT device that connects to a network to receive IoT services. Likewise, computer device 200 may be an example any of the devices illustrated in or referred to in FIGS. 3-5, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. Processing circuit 210 is an example of a core. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process.

Operating memory 220 may include 4^{th} generation double data rate (DDR₄) memory, 3^{rd} generation double data rate (DDR₃) memory, other dynamic random-access memory (DRAM), High Bandwidth Memory (HBM), Hybrid Memory Cube memory, 3D-stacked memory, static random-access memory (SRAM), or other memory, and such memory may comprise one or more memory circuits integrated onto a DIMM, SIMM, SODIMM, or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although, FIG. 2 illustrates bus 240 as a single passive bus, other configurations, such as a collection of buses, a collection of point to point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing. In yet another example, input interface 260 and/or output interface 270 may include a universal asynchronous receiver/transmitter (“UART”), a Serial Peripheral Interface (“SPI”), Inter-Integrated Circuit (“I2C”), a General-purpose input/output (GPIO), and/or the like. Moreover, input interface 260 and/or output interface 270 may include or be interfaced to any number or type of peripherals.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long-Term Evolution (LTE) adapter, or a 5G adapter.

Although computing device 200 is illustrated with certain components configured in a particular arrangement, these components and arrangement are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

Some examples of computing device 200 include at least one memory (e.g., operating memory 220) adapted to store run-time data and at least one processor (e.g., processing unit 210) that is adapted to execute processor-executable code that, in response to execution, enables computing device 200 to perform actions.

### Illustrative Systems

FIG. 3 is a block diagram illustrating an example of a device (300). Device 300 may include front screen 361 and rear screen 362. Some examples of device 300 include hinge 365, and other examples of device 300 do not include a hinge. Although not visible in FIG. 3, device 300 may also include a controller which may be disposed inside front screen 361, disposed inside rear screen 362, or may have one portion inside front screen 361 and another portion inside rear screen 362. In some examples, one portion of a controller is disposed inside front screen 361, another portion of the controller is disposed inside rear screen 362, and the two portions are connected through hinge 365. In some examples, device 300 may display one of more buttons on front screen 361, including, for example, night light settings button 352 and night light toggle button 353. Device 300 may also include many other components not shown, such as at least one speaker, a GPS, a plug for a power adapter, and/or the like.

As shown, in the example illustrated, device 300 is a two-screen device in which front screen 361 is physically coupled to rear screen 362 via hinge 365. Device 300 may be placed in a “tent” mode as illustrated in FIG. 3, in which device 300 is physically supported on a flat surface with the bottom of front screen 361 and the bottom of rear screen 362 in contact with the flat surface and supporting the weight of device 300. In the example shown, front screen 361 and rear screen 362 are facing opposite directions from each other, with both front screen 361 and rear screen 362 angled upwards. In some examples, as shown in FIG. 3, I directions are not exactly opposite, i.e., not 180 degrees, but rather opposite and offset, with both screens angled upwards, as shown in FIG. 3. In some examples, this is how device 300 is placed when device 300 is in “tent” mode.

In some examples, device 300 is permanently in “tent” mode, and cannot be adjusted to any other mode. In some examples, device 300 is a foldable device, which is capable of being placed in “tent” mode or being folded so that front screen 361 and front screen 362 collapse to touch each either such that device 300 is closed so as to be easily transportable. For instance, a user may use device 300 at home, and the user may also bring device 300 with the user while traveling, and folding device 300 closed makes it easy to transport device 300 while traveling. In some examples, folding may be accomplished via hinge 365, which may also allow device 300 to remain standing in the open “tent” position. Other examples of device 300 do not include a hinge, and the folding and “tent” mode is accomplished in another suitable manner.

Device 300 may be used to illuminate a room through direct and indirect lighting, with front screen 361 used as an alarm clock. Device 300 may also be operable to provide various smart device functions in some examples. Device 300 may operate as a built-in, mobile, portable alarm clock, via front screen 361. Among other things, front screen 361 may display the current time, as shown in FIG. 3. Device 300 may display various things on front screen 361, including, in the example illustrated in FIG. 3, the time of any alarms that have been set, the temperature and/or other weather information, and/or the like.

Front screen 361 may also display one or more “soft” buttons, which may be used for activating various functions. Such buttons may include, for example, night light settings button 352 and night light toggle button 353, as shown in FIG. 3. When a soft button on front screen 361 is pressed, the corresponding function for the button may be activated. In other examples, physical buttons may be employed instead of “soft” buttons.

A user may be able to control the alarm clock functions provided by controller 371 for front screen 361 in various ways in various examples. In some examples, front screen 361 is a touch screen, in which various functions may be controlled by actuating digital buttons by touch on front screen 361. In some examples, screen 362 is also a touch screen. In some examples, the alarm function and/or other functions may also or instead be controlled by any of various other means, such as voice control, control from another remote device such as a remote controller, by a mobile device such as a smart phone or tablet via an app, and/or the like. Such user control may be used to set one or more alarms, to adjust the time, to change the way time is displayed, and/or the like.

A user may also be able to use various other functions associated with an alarm, such as cancelling an alarm, activating a snooze function, and/or the like. In some examples, device 300 is capable of connecting to a network, and in other examples, device 300 lacks means of connecting to a network. In some examples in which device 300 is connected to a network, device 300 may receive some input via the network connection.

Device 300 may receive power through various means in various examples. In some examples, device 300 is battery-powered, and in some examples, device 300 is not battery powered. In some examples, device 300 can be plugged in to a power adapter to receive power. In some examples, rear screen 362 provides lighting only when device 300 is plugged into a power adapter, in order to conserve power when device 300 is not plugged in.

In some examples, rear screen 362 can be used to provide a night light function. In some examples, device 300 has a mode in which the nightlight is automatically on at night. In other examples, the nightlight is on only when turned on. In some examples, front screen 361 has a digital button for the night light toggle button 353—so that the night light may be turned on or off by the user touching the night light toggle button 353.

In some examples, when night light toggle button 353 on front screen 361 is pressed and the night light is off, the night light lighting may be provided by rear screen 362. In various other examples, the user can cause the night light to be turned on by other means, such as voice control, remote control by external means such as a smart phone or tablet app, and/or the like.

In some examples, when the night light function is on, rear screen 362 may glow such that the user can navigate around the user's location in the dark. In some examples, when the night light is on, rear screen 362 gently lights up the room using warm colors (e.g., yellow). In some examples, by using gentle illumination with warm colors, the room can be navigated without turning on the full lights, while not negatively impacting the ability to sleep, including not causing the suppression of melatonin of those in the room.

The distinction between “warm” and “cool” colors is related to the observed contrast in landscape light, between the “warm” colors associated with daylight or sunset, and the “cool” colors associated with a gray or overcast day. Warm colors are often said to be hues from red through yellow, browns and tans included; cool colors are often said to be the hues from blue green through blue violet, most grays included. The general idea is the warm colors are red, orange and yellow, and the cool colors are green, blue and magenta.

In some examples, the light provided by the night light function of screen 362 is user-adjustable, so that a user may adjust the brightness of the light, the colors generated, the duration of the night light, the time that the night light turns on, and/or the like. In some examples, although not shown in FIG. 3, the user may adjust such aspects of the night light function via a night light setting function, which causes front screen 461 to display a menu screen which allows the user to adjust settings for the night light. This menu screen and/or the main front screen may, in some examples, have volume buttons that may be used to make the night light brighter or darker. In addition to the colors being user adjustable, in some examples, the night light may project a custom image via ambient light when set by the user. In some examples, a user may access adjust night light settings by pressing night light settings button 352.

In some examples, the night light may remain on until turned off, and/or until dawn simulation begins, if the dawn simulation function is on. In some examples, when the night light turns on, the night light is automatically turned off after a particular period of time, which may be user-adjustable in some examples. In other examples, device 300 may be responsive to motion, so that device 300 turns off the night light when the user is detected as sleeping, and may turn back on if motion is detected. In some examples, motion may be sensed by a motion sensor that is part of device 300 itself. In other examples, device 300 receive a notification that another device, such as a motion sensor in the room, has detected motion. For example, device 300 may be connected to a motion sensor in some manner, or device 300 may be connected to a network, and the room may include a motion sensor that is an IoT device, and device 300 may receive pertinent information based on the motion sensor over the network connection to which device 300 is connected.

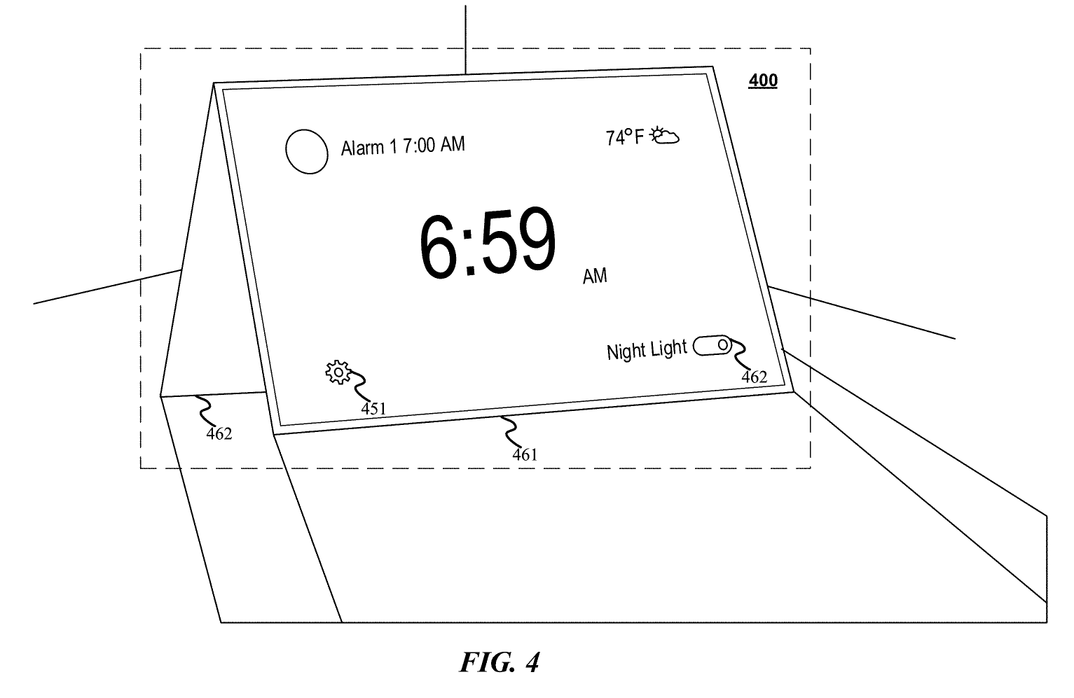

FIG. 4 is a block diagram illustrating an example of a device (400). Device 400 may be employed as an example of device 300 of FIG. 3.

Rear screen 462 can be used to provide a dawn simulation function. In some examples, when the dawn simulation function is active, rear screen 462 provides indirect light such that the indirect light gradually increases beginning at a time proximate to a predetermined time until the predetermined time is reached. The time proximate to the predetermined time could be a few minutes, several minutes, 30 minutes, 45 minutes, or some other suitable period of time, which is user-adjustable in some examples. In some examples, the time may be from 20 minutes to two hours, from 30 minutes to 45 minutes, or the like. In some examples, the brightness of the lighting increases in a substantially uniform manner during the time. In various examples, the predetermined time may be the alarm time set by the user, the time of dawn at the location of device 400, the time of dawn at the equator (i.e., Earth's equator) at the longitude of the location of the device, or another suitable time. In this way, rear screen 462 may slowly light up the room during the dawn hour, or whatever time is effectively used as dawn for this purpose. The location of the device may be determined by a GPS on the device, by user entry of the location of the device, and/or by other suitable means.

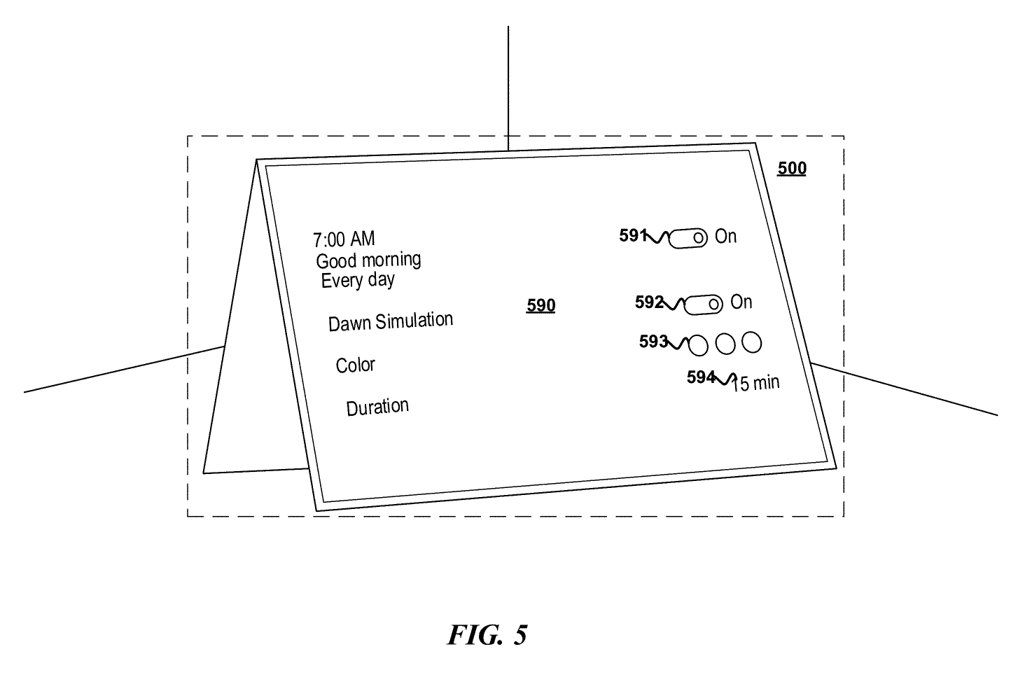

While light is being provided by rear screen 462 for dawn simulation, one or more cool colors may be used (e.g., blue). Like the light provided by the night light, in some examples, the light provided by the dawn simulation may be user-adjustable, for factors such as the brightness of the light, the amount of time prior to the predetermined time that the light is first provided begins, the colors used for the dawn simulation, duration, and/or the like. In some examples, the user may press dawn simulation settings button 451 to access a separate screen that can be used to control dawn simulation settings and/or other settings, such as alarm settings. An example of such a separate screen is discussed in greater detail below with regard to FIG. 5.

By gradually increasing light brightness during dawn simulation, a user may be awakened gently, in in such a way that may support morning cortisol response, help balance melatonin, help with depression, and/or help with seasonal affective disorder. The dawn simulation function may also aid the user in being alert when the user is awakened, instead of still being groggy and possibly falling back asleep or wishing to use the snooze button.

In some examples, in addition to the glow of screen 462, the dawn simulation may also include a gradually increasing sound, such as the sound of birds, ocean waves, and/or the like. In some examples, device 400 may control other devices in the room, such as lights in the room, for example, to have the lights in the room increase in brightness during the dawn simulation. For example, the other devices may be controlled by Bluetooth, device 400 and the controlled devices may be IoT devices, and/or the like.

In some examples, front screen 461 operates as an alarm clock. In some examples, a user may set an alarm on device 400. In some examples, when an alarm has been set, device 400 wakes the user at the alarm time. For instance, in some examples, an auditory alarm is sounded at the set alarm time. In other examples, just the dawn simulation is used to wake the user at the set alarm time.

In some examples, the manner in which the user is awakened at the set alarm time may be configurable by the user. In some examples, the night light and/or dawn simulation and other glowing scenarios, such as glowing during the alarm, may happen on both screen 461 and screen 462 rather than just screen 462, for increased total brightness. Screen 462, and also screen 461 in some examples, may flash and/or pulse when the alarm goes off, and a flash may also be turned on for increased brightness when the alarm goes off. In some examples, rather than having the alarm go off at the set alarm time, the user may use just the dawn simulation to be woken up.

As discussed, the time at which dawn is set for the dawn simulation may vary in different examples, and is user-adjustable in some examples. For instance, a user may set dawn to wake the user up at or around the time that the alarm of the alarm clock is set. A user may alternatively set the dawn function to mimic the current sunrise. For example, this may be desirable to a user who sleeps in an unnaturally dark environment. A user may alternatively set the dawn function to match the sunrise at the equator at the longitude of the device. This may, for example, be desirable to users that are struggling with sleep, tend to use light blocking shades, and try to align their sleep schedules to a clock.

In some examples, instead of the using the actual device location, the device may have a home location set, and the home location may be used instead of the actual device location. For example, the dawn simulation function may be set that the dawn function mimics the sunrise at the user's home location. As another example, the dawn simulation may be set to match the sunrise at the equator at the longitude of the home location of the device.

Although FIG. 3 and FIG. 4 are discussed separately, in some examples, the properties of the device of FIG. 3 and the device of FIG. 4 are combined in a single device. For example, the device may be capable of performing both night light functions and dawn simulation functions, if both functionalities are turned on. For instance, the device may, based on control by the controller, cause the rear screen to operate with a night light function during the night, either continually left on or turned off while the user is determined to be asleep or left on for a predetermined period of time, with the dawn simulation function replacing the night light function on the rear screen, based on control by the controller, and the appropriate time, such as a time proximate to the predetermined time.

FIG. 5 illustrates device 500, which may be employed as an example of device 400 of FIG. 4. FIG. 5 illustrates an example of device 500 displaying a dawn simulation settings screen 590 on the front screen (e.g., front screen 461 of FIG. 4) of device 500.

As discussed above, in some examples, dawn simulation and alarm settings screen may be accessed in various ways, such as, in some examples, by pressing a dawn simulation settings button (e.g., dawn simulation button 451 of FIG. 4) on the main screen.

Dawn simulation and alarm settings screen 590 may include alarm toggle button 591, dawn simulation toggle button 592, dawn simulation color selection 593, and dawn simulation duration selection 594. In some examples, screen 590 is a touch screen, and the controls may be accessed by the user by touching the screen.

Alarm toggle button 591 may be used to toggle the alarm on and off. Dawn simulation toggle button 592 may be used to toggle the dawn simulation on and off. Dawn simulation color selection 593 may be used to select the color provided by the dawn simulation. Dawn simulation duration selection 594 may be used to select the duration of the dawn simulation.

As discussed above, the two screens of the device may be physically coupled together and enabled to be placed in a “tent” mode in different ways in different examples. In some examples, the two screens are physically coupled together via a hinge. In other examples, the device is permanently in a “tent” mode, and is not adjustable away from “tent” mode. In some examples, the device, including the two screens, together act as a single foldable panel which folds in half.

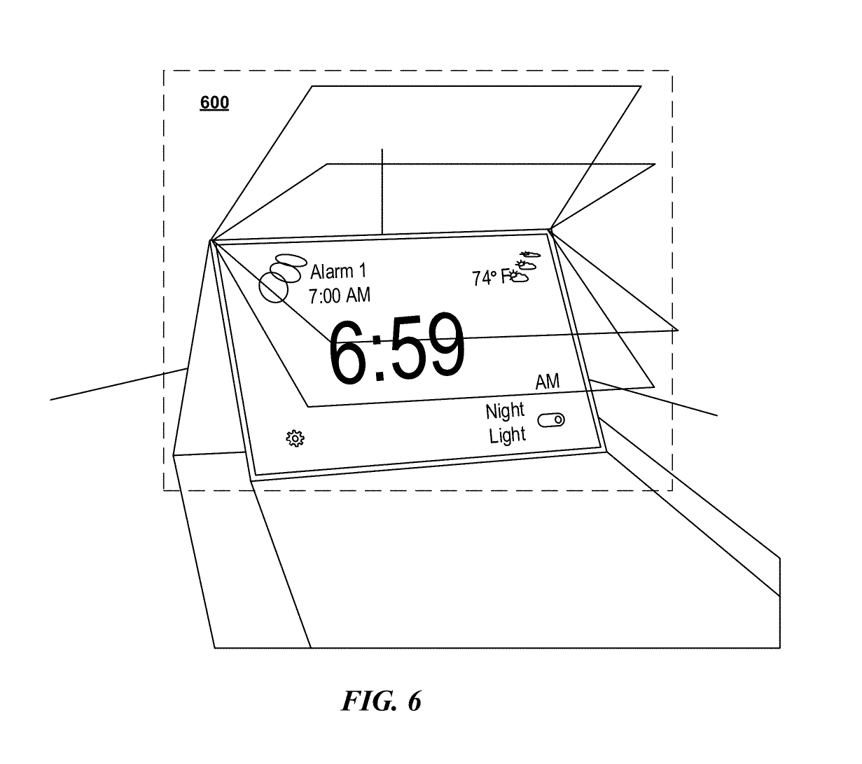

For instance, FIG. 6 illustrates an example of device 600, which is an example of device 300 of FIG. 3 and/or device 400 of FIG. 4. FIG. 6 illustrates an example of the folding action by which device 600 may operate as a single, foldable panel which folds in half, with each half operable as a separate screen.

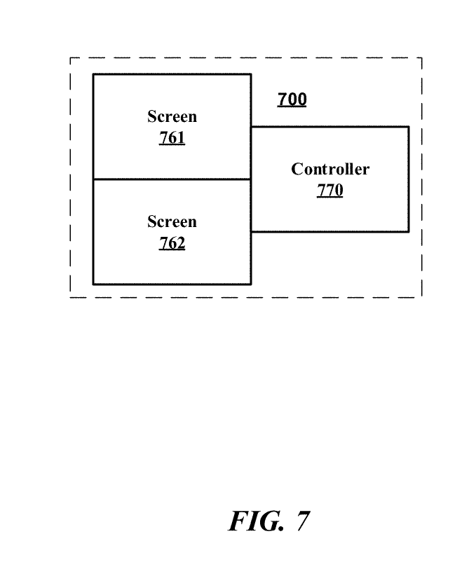

FIG. 7 is a block diagram illustrating an example of a device 700. Device 700 may include screen 761, screen 762, and controller 770.

In some examples, screen 762 is physically coupled to screen 761, and is facing a different direction than screen 761. In some examples, controller 770 is configured to cause screen 761 to operate as a clock display, and further configured to cause screen 762 to provide indirect light such that the indirect light gradually increases beginning at a time proximate to a predetermined time (e.g., a predetermined dawn time) until the predetermined time is reached. In some examples, device 700 may be placed in a tent mode in which screen 761 is a front screen and screen 762 is a rear screen.

Controller 770 may be disposed inside screen 761, disposed inside screen 762, or may have one portion inside screen 761 and another portion inside screen 762. In some examples, one portion of controller 770 is disposed inside screen 761, another portion of controller 770 is disposed inside screen 762, and the two portions are connected through a hinge that physically couples screen 761 to screen 762.

Device 700 may operate as a built-in, mobile, portable alarm clock, via screen 761, based on control provided by controller 770. In some examples, controller 770 is configured to cause screen 761 to operate as an alarm clock. Among other things, controller 770 may cause screen 761 to display the current time. In some examples, a user may set an alarm on device 700.

When an alarm has been set, controller 770 causes device 700 to wake the user at the alarm time. For instance, in some examples, controller 770 may cause auditory alarm to be sounded at the set alarm time. In other examples, controller 770 may use just the dawn simulation to wake the user at the set alarm time. In some examples, the manner in which the user is awakened at the set alarm time may be configurable by the user.

Controller 770 may also cause the front screen to display one or more soft buttons, which may be used for activating various functions. When a soft button on screen 761 is pressed, controller 770 may cause the corresponding function for the button to be activated. In other examples, physical buttons may be employed instead of “soft” buttons. In some examples, the alarm function and/or other functions may also or instead be controlled by any of various other means, such as voice control, control from another remote device such as remote control, by a mobile device such as a smart phone or tablet via an app, and/or the like. Such user control may be used to set one or more alarms, to adjust the time, to change the way time is displayed, and/or the like. The various functions provided by such user control may be controlled by controller 770, subject to input from screen 761 and/or other forms of received input.

In some examples, controller 770 may be a processor or include a processor, such as an example of processing circuit 210 of FIG. 2. The processor may include a microcontroller, a CPU, and/or the like.

Controller 770 may be configured such that screen 762 can be used to provide a night light function. In some examples, when the night light function is on, controller 770 causes screen 762 to glow such that the user can navigate around the user's location in the dark. In some examples, device 700 has a mode in which the nightlight is automatically on at night. In other examples, the nightlight is on only when turned on. In some examples, screen 761 has a soft button for the night light, which may be turned on or off by the user touching the soft night light button.

In some examples, when the soft button for the night light on screen 761 is pressed, controller 770 may determine based on signals provided by screen 761 to controller 770 that the soft night light button has been pressed, and may then accordingly cause the night light lighting to be provided by screen 762. In various other examples, the user can cause the night light to be turned on by other means, such as voice control, remote control by external means such as a smart phone or tablet app, and/or the like.

### Illustrative Processes

For clarity, the processes described herein are described in terms of operations performed in particular sequences by particular devices or components of a system. However, it is noted that other processes are not limited to the stated sequences, devices, or components. For example, certain acts may be performed in different sequences, in parallel, omitted, or may be supplemented by additional acts or features, whether or not such sequences, parallelisms, acts, or features are described herein. Likewise, any of the technology described in this disclosure may be incorporated into the described processes or other processes, whether or not that technology is specifically described in conjunction with a process. The disclosed processes may also be performed on or by other devices, components, or systems, whether or not such devices, components, or systems are described herein. These processes may also be embodied in a variety of ways. For example, they may be embodied on an article of manufacture, e.g., as processor-readable instructions stored in a processor-readable storage medium or be performed as a computer-implemented process. As an alternate example, these processes may be encoded as processor-executable instructions and transmitted via a communications medium.

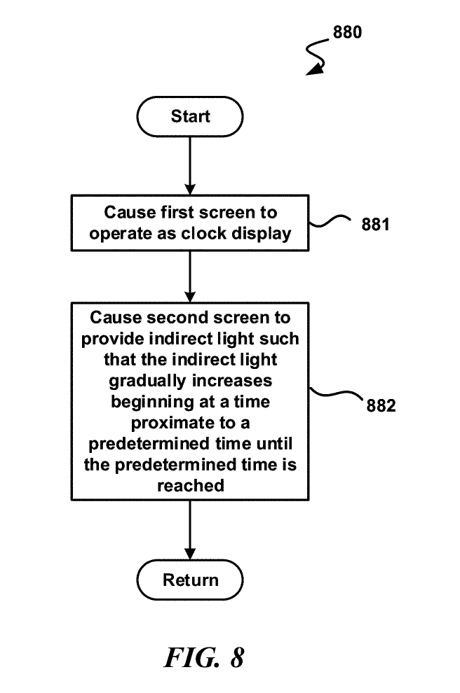

FIG. 8 is a flow diagram illustrating an example process (880) that may be performed, e.g., by the device of FIG. 3, FIG. 4, and/or FIG. 7.

In the illustrated example, step 881 occurs first. At step 881, in some examples, a first screen is caused to operate as a clock display.

As shown, step 882 occurs next in some examples. At step 882, in some examples, a second screen is caused, via at least one processor, to provide indirect light such that the indirect light gradually increases beginning at a time proximate to a predetermined time (e.g., a predetermined dawn time) until the predetermined time is reached. In some examples, the second screen is physically coupled to the first screen. In some examples, the second screen is also facing a different direction than the first screen.

The process may then proceed to a return block, where other processing is resumed.

### Conclusion

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
a device, including:
a first screen;
a second screen that is physically coupled to the first screen, and is facing a different direction than the first screen; and
a controller that is configured to cause the first screen to operate as a clock display, and further configured to cause the second screen to provide dawn simulation, including providing lighting that increases from a time proximate and prior to a predetermined time to the predetermined time.

2. The apparatus of claim 1, wherein the first and second screen are at an angle such that device is capable of supporting the device while the device is placed on a flat surface such that the second screen is facing in a direction opposite of but offset from the first screen with the first screen angled upwards and the second screen angled upwards.

3. The apparatus of claim 1, wherein the controller is disposed inside of at least one of the first screen or the second screen.

4. The apparatus of claim 1, wherein the controller is configured to cause the first screen to display a current time.

5. The apparatus of claim 1, wherein the indirect light provided from the time proximate and prior to the predetermined time consists of one or more cool colors.

6. The apparatus of claim 1, wherein the predetermined time is a time of dawn at a location of the device.

7. The apparatus of claim 1, wherein the predetermined time is a time of dawn at a home location of the device.

8. The apparatus of claim 1, wherein the determined time is the time of dawn at the equator of Earth at a longitude of the device.

9. The apparatus of claim 1, wherein the determined time is the time of dawn at the equator of Earth at a longitude of a home location of the device.

10. A method, comprising:
operating a first screen as a clock display; and
operating, via at least one processor, causing a second screen to provide indirect light such that the indirect light gradually increases beginning at a time proximate to a predetermined time until the predetermined time is reached, wherein the second screen is physically coupled to the first screen, and is facing a different direction than the first screen.

11. The method of claim 10, further comprising:
allowing an alarm time to be set; and
when the alarm time is set, causing a user to be awakened at the set alarm time.

12. The method of claim 11, wherein the predetermined time is the set alarm time.

13. An apparatus, comprising:
a device, including:
a front screen;
a rear screen that is physically coupled to the front screen, such that the front screen and the rear screen are at an angle such that the device is capable of supporting the device while the device is placed on a flat surface such that the rear screen is facing in a direction opposite of but offset from the front screen with the front screen angled upwards and the rear screen angled upwards; and
a controller that is configured to cause the front screen to operate as an alarm clock, further configured to cause the rear screen to gently glow with one or more warm colors until a time proximate and prior to a predetermined time, and further configured to cause, at the time proximate and prior to the predetermined time, the gentle glow of the one or more warm colors to be replaced by one or cool colors via indirect light such that the indirect light increases at a substantially uniform rate beginning at the time proximate to a predetermined time until the predetermined time is reached, such that the time between the time proximate and prior to the predetermined time and the proximate time is from twenty minutes to two hours.

14. The apparatus of claim 13, wherein the predetermined time is at least one of a time of dawn at a location of the device, the time of dawn at the equator of Earth, or an alarm time.

15. The apparatus of claim 13, wherein the controller is configured to allow an alarm time to be set, and to cause, when the alarm is set, a user to be awakened at the set alarm time.

16. The apparatus of claim 15, wherein the predetermined dawn time is the set alarm time.

17. The apparatus of claim 13, wherein the controller is configured to cause the second screen to activate a night light function when the night light function is actuated.

18. The apparatus of claim 17, wherein the controller is configured to cause the first screen to display at least a current time and a night light button, wherein the first screen is a touch screen, and wherein the night light function is actuated in response to the night light button on the first screen being pressed.

19. The apparatus of claim 17, wherein, the controller is configured to cause, when the night light function is actuated, the rear screen to gently glow with one or more warm colors.

20. The apparatus of claim 19, wherein, in response to the night light function being actuated, the controller is configured to cause the rear screen to gently glow with the one or more warm colors until the time proximate to the predetermined dawn time, and wherein at the time proximate to the predetermined dawn time, the glow of the one or more warm colors is replaced by one or more cool colors via the indirect light that increases beginning at the time proximate to a predetermined time until the predetermined dawn time is reached.
